(19) United States
(12) Patent Application Publication
(10) Pub. No.: US 2007/0168220 A1
(43) Pub. Date: Jul. 19, 2007

(54) Method and system for delivering educational content

(76) Inventors: James D. Sagar, Scottsdale, AZ (US); Nancy L. Sagar, Scottsdale, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/333,778

(22) Filed: Jan. 17, 2006

(51) Int. Cl. G06Q 10/00; A63B 71/00

(52) U.S. Cl. 705/2; 482/8

(57) ABSTRACT

The invention provides a method, system and computer program for delivering an exercise for accomplishing a goal. A method for delivering the exercise includes an identification receiving step of receiving identification information regarding a user, a goal receiving step of receiving goal information, and a delivering step of delivering an exercise based on the identification information and the goal information. The exercise may include a reading portion and an action portion. The reading portion is typically a subset of a larger body of material on a subject, while the action portion allows for input of information by a user. User input of the action portion produces a deliverable relevant to accomplishing the user's goal.

### DESCRIPTION OF THE INVENTION

1. Field of the Invention

The present invention relates to a method and system for delivering educational content.

2. Background of the Invention

Conventional methods and techniques for delivering educational content often utilize books, DVDs, CDs, websites, and other forms of media. These forms of media are generally static (i.e., the contents do not change once published), and as such, the educational content contained therein is typically written and presented for use by a wide and varied audience. Users of such media are often overwhelmed when looking for specific information or educational experiences from within a broad subject. The broad and standardized presentation of conventional educational media does not lend itself to providing customized solutions to users with specific needs. Furthermore, as conventional educational media is often geared toward teaching theoretical concepts learned by reading text, users seeking to learn how to accomplish a specific goal are often left unsatisfied.

### SUMMARY OF THE INVENTION

In view of the foregoing, the present invention provides a method, system and computer program for delivering educational content. More specifically, the present invention provides a method, system and computer program for delivering a customized exercise for accomplishing a goal.

According to one aspect of the invention, a method for delivering a customized exercise for accomplishing a goal includes an identification receiving step of receiving identification information regarding a user, a goal receiving step of receiving goal information, and a delivering step of delivering an exercise based on the identification information and the goal information. Typically, the exercise includes a reading portion and an action portion. The action portion allows for input of information by the user. Completion of the action portion produces a deliverable document which aids the user in accomplishing his goal.

According to one aspect, identification information is received by displaying a list of identification information that is then selectable by a user. The identification information displayed may, for example, allow a user to indicate his skill level in the particular subject.

According to another aspect, goal information is received by displaying a list of goal information that is then selectable by a user. According to one embodiment, the goal information that is displayed is dependent on the identification information that is received from the user. That is, the list of goals presented may be different for different types of users.

According to yet another aspect, the display and selection of goal information may occur in two or more steps. For examples, a first goal displaying step displays a list of selectable broad goals and then a second goal displaying step displays a list of selectable narrow goals in response to a selection of a broad goal. In this way, the invention allows for a user to more specifically define the goal he wishes to accomplish.

It is to be understood that the descriptions of this invention herein are exemplary and explanatory only and are not restrictive of the invention as claimed.

### BRIEF DESCRIPTION OF THE DRAWINGS

FIG. 1 shows method steps according to one embodiment of the invention.

FIG. 2 shows system units that implements inventive method according to one embodiment.

FIG. 3A shows the method steps for receiving identification information according to one embodiment of the invention.

FIG. 3B shows a list of displayed identification information according to one embodiment of the invention.

FIG. 3C shows a list of displayed identification information for the marketing subject area according to one embodiment of the invention.

FIG. 4A shows the method steps for receiving goal information according to one embodiment of the invention.

FIG. 4B shows the method steps for displaying lists of goals according to one embodiment of the invention.

FIG. 4C shows a list of displayed broad goals according to one embodiment of the invention.

FIG. 4D shows a list of displayed narrow goals according to one embodiment of the invention.

FIG. 4E shows a list of displayed broad goals for the marketing subject area according to one embodiment of the invention.

FIG. 4F shows a list of displayed narrow goals for the marketing subject area according to one embodiment of the invention.

FIG. 5A shows a sample project plan for the marketing subject area according to one embodiment of the invention.

FIG. 5B shows a sample detailed project plan for the marketing subject area according to one embodiment of the invention.

FIGS. 6A to 6F show a sample exercise for the marketing subject area according to one embodiment of the invention.

### DESCRIPTION OF THE EMBODIMENTS

Reference will now be made in detail to the present exemplary embodiments of the invention, examples of which are illustrated in the accompanying drawings.

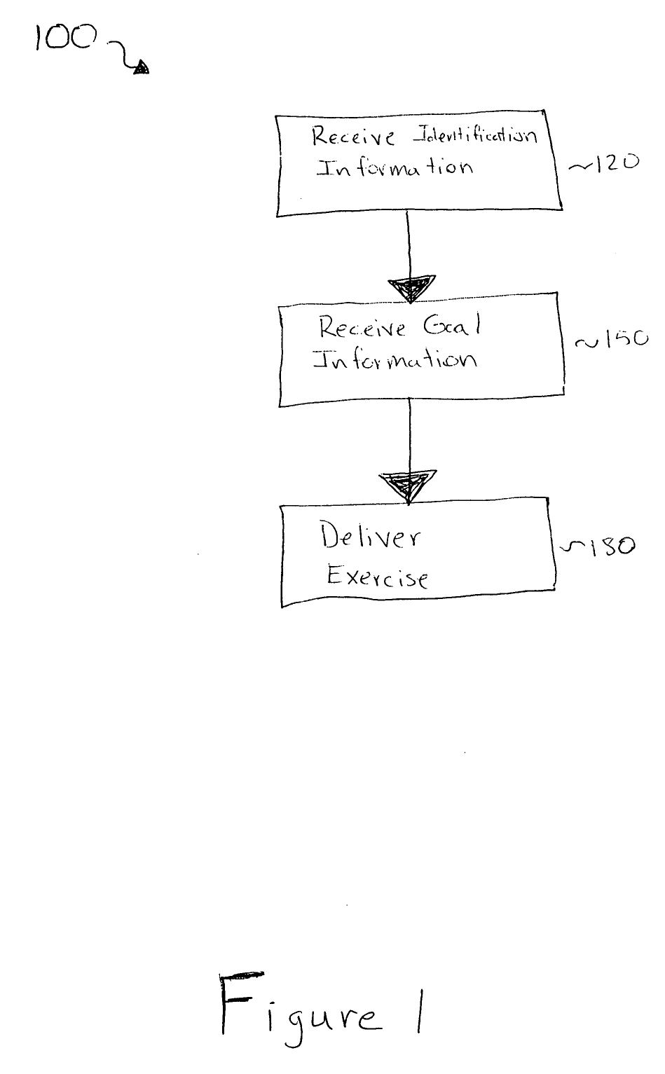

FIG. 1 shows method steps according to one embodiment of the invention. Method 100 includes a receive identification information step 120, a receive goal information step 150, and a deliver exercise step 180. The method is applicable for delivering a customized exercise for accomplishing a goal with regard to any educational subject matter. Preferably, the subject matter and goal are ones that lend themselves to a hands-on “learning-by-doing” approach rather than a merely theoretical approach.

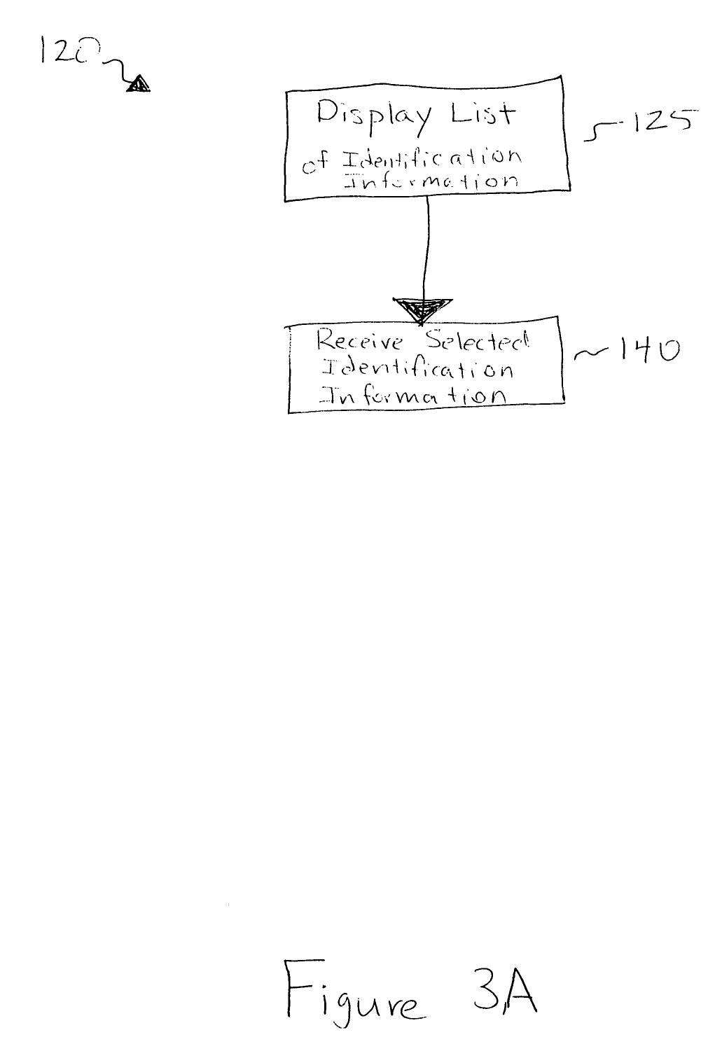

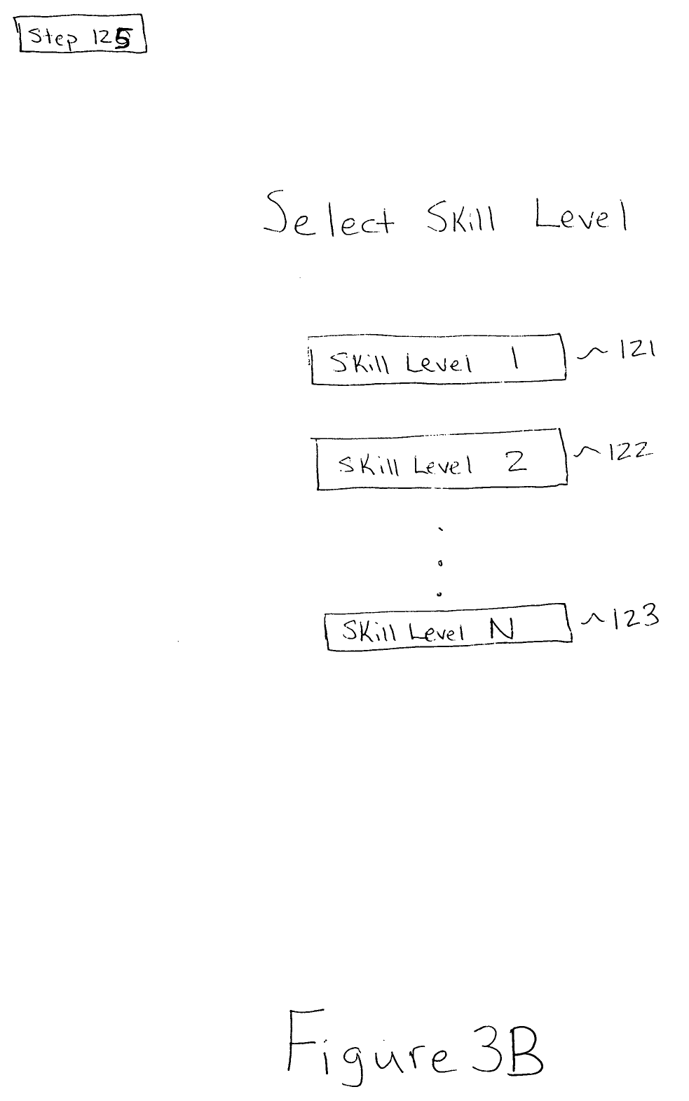

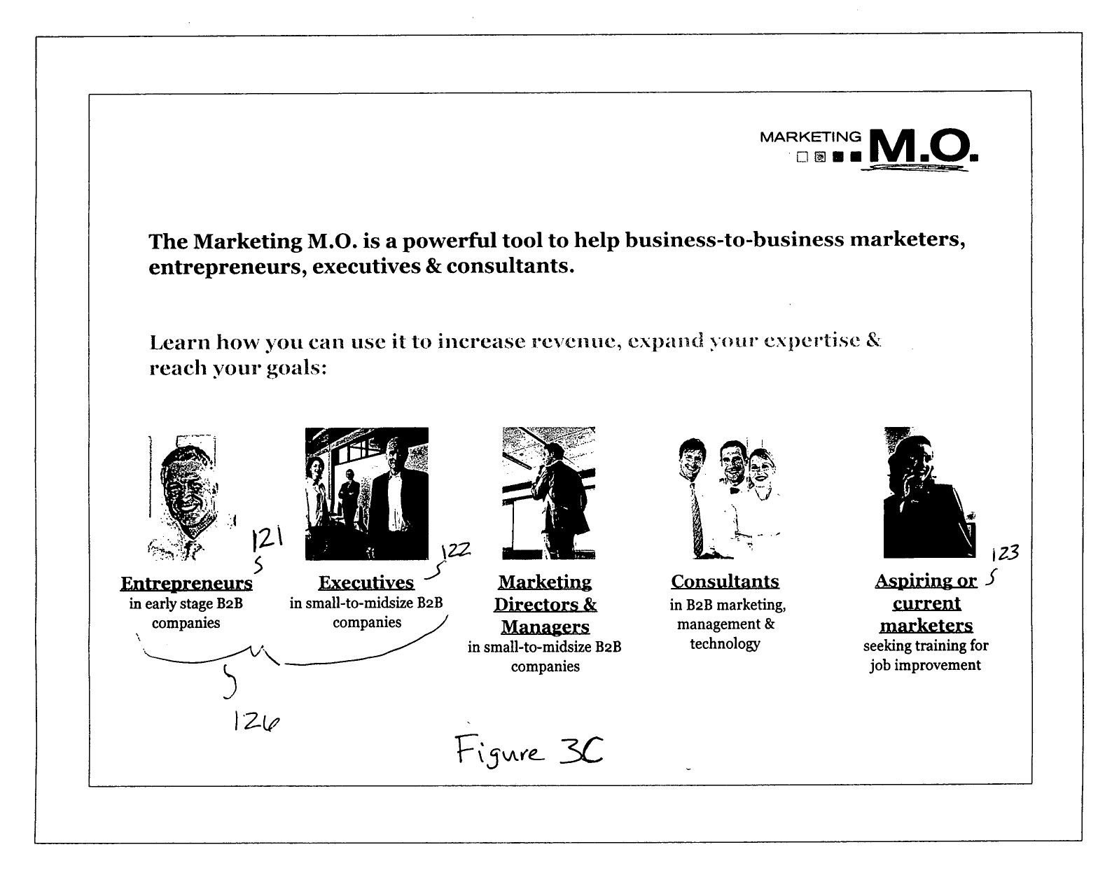

In step 120, identification information regarding the user is received. Preferably, the identification information is information that indicates the skill level of the user with regard to the particular subject matter. In this way, the exercise delivered to the user can be customized to the skill, ability, and/or specific needs of a particular user. The identification information may be received in any manner. For example, the identification information may be received via interaction with a computer program using a pointing device (e.g., a mouse), via interaction with a touch screen, via an e-mail, via a magnetic card swipe, via biometrics (e.g., fingerprint identification), or via voice recognition. The process for receiving identification information and examples of types of identification information utilized will be discussed in more detail with reference to FIGS. 3A to 3C below.

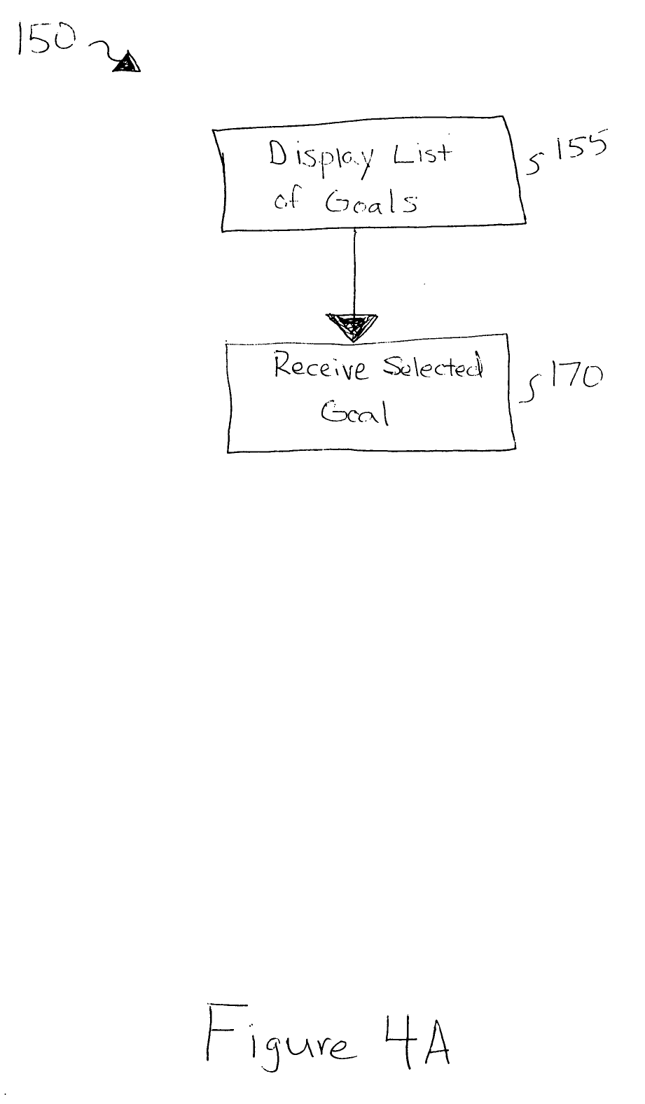

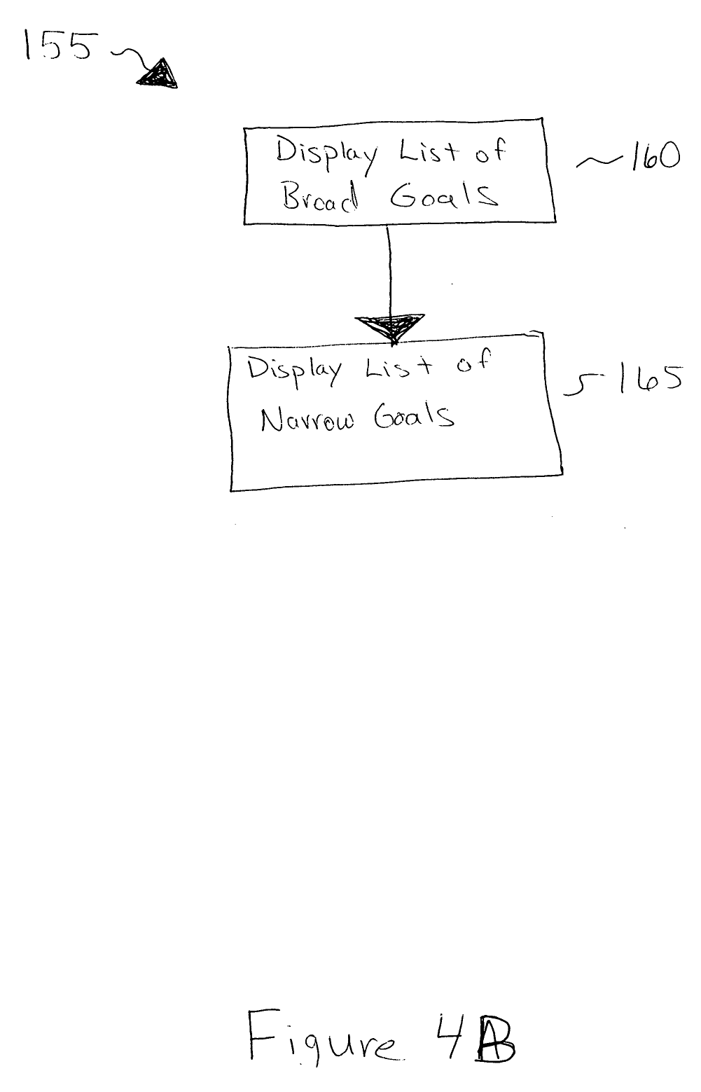

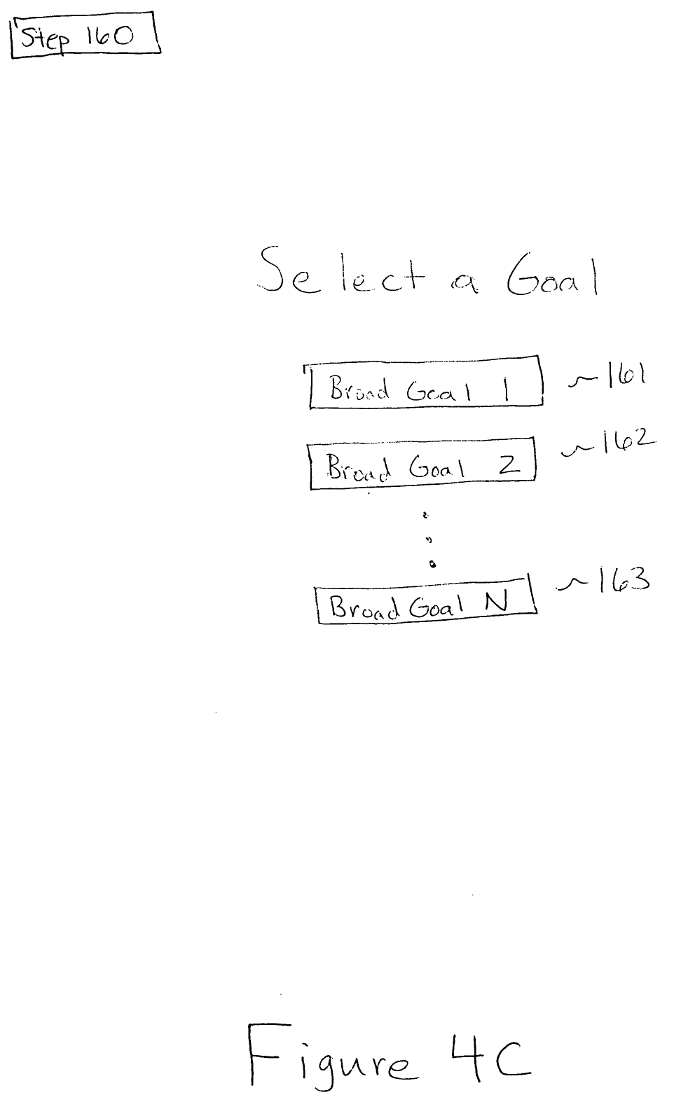

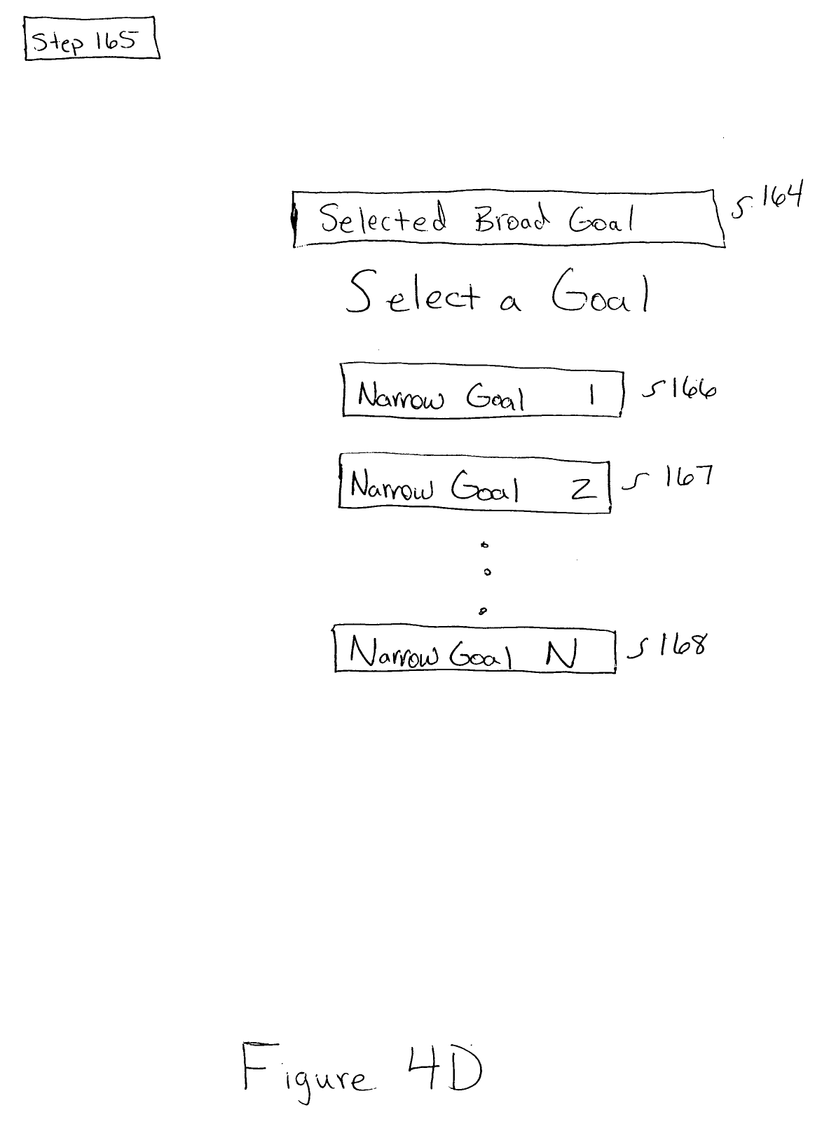

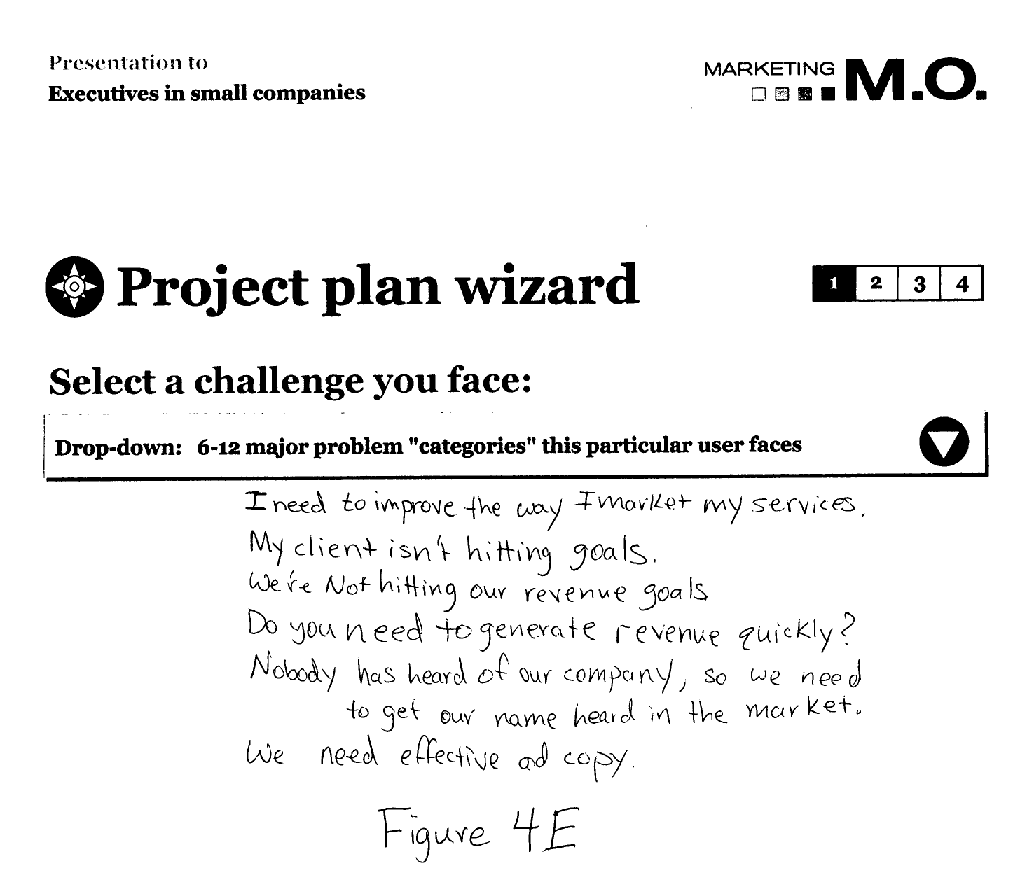

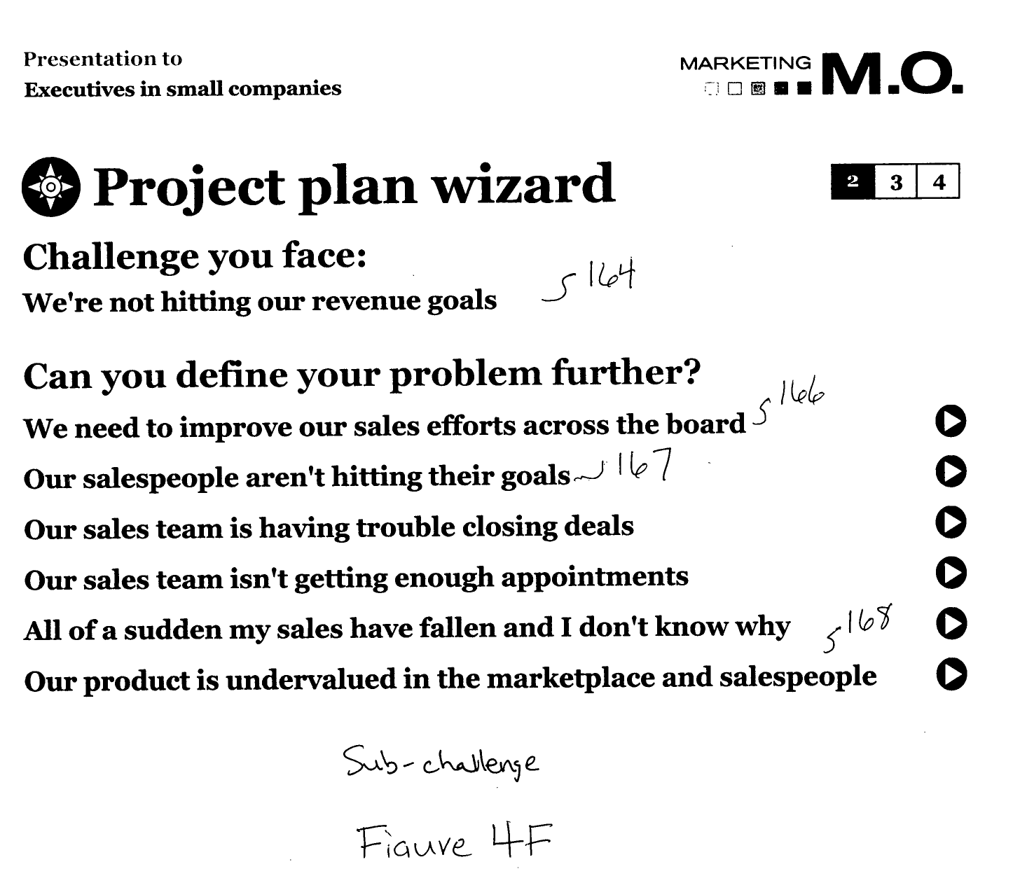

In step 150, goal information is received. For example, the goal information may be a goal, problem, challenge, or task that the user is seeking aid in completing or solving. In one embodiment of the invention, the goal information that the user may enter is dependent on the identification information received. That is, the specific goals or challenges that the user may select are tailored to the type of person the user is (e.g., high or low skill level in a particular subject). Again, the goal information may be received in any manner. The process for receiving goal information and examples of types of goals will be discussed in more detail with reference to FIGS. 4A to 4F below.

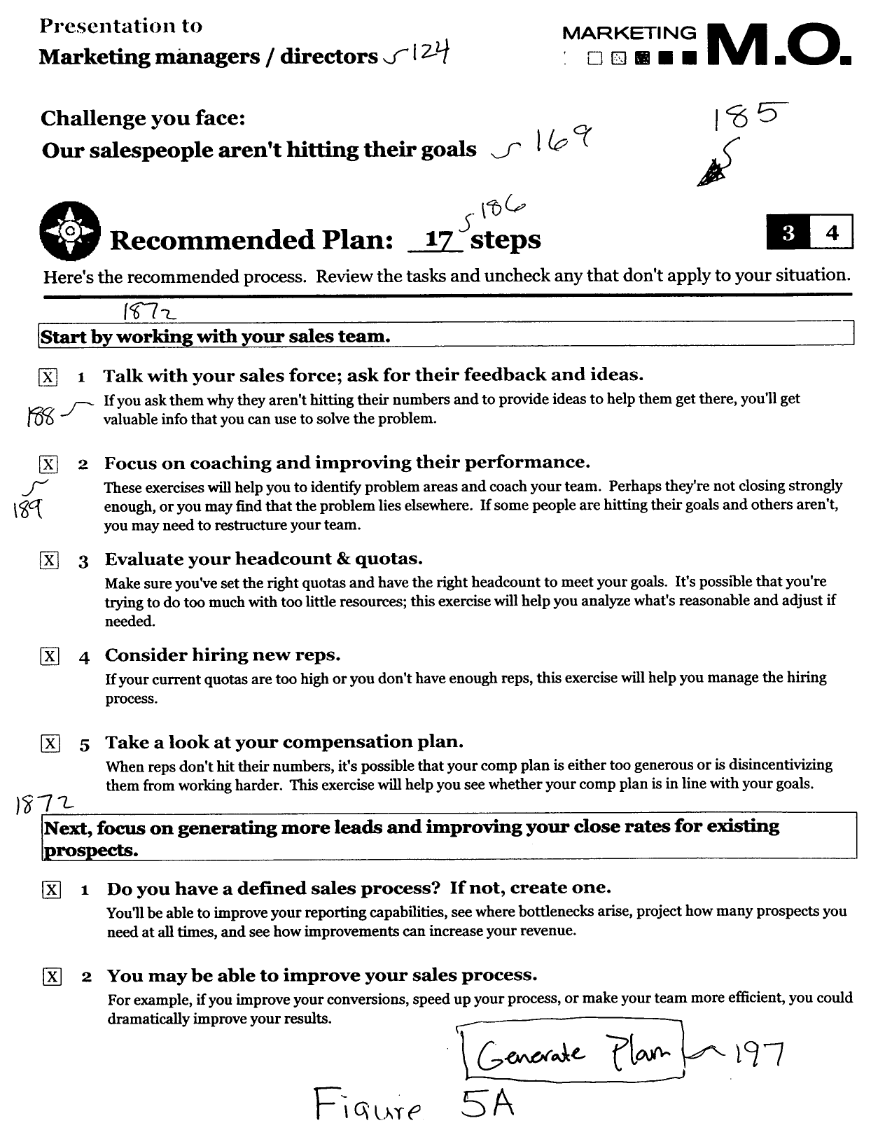

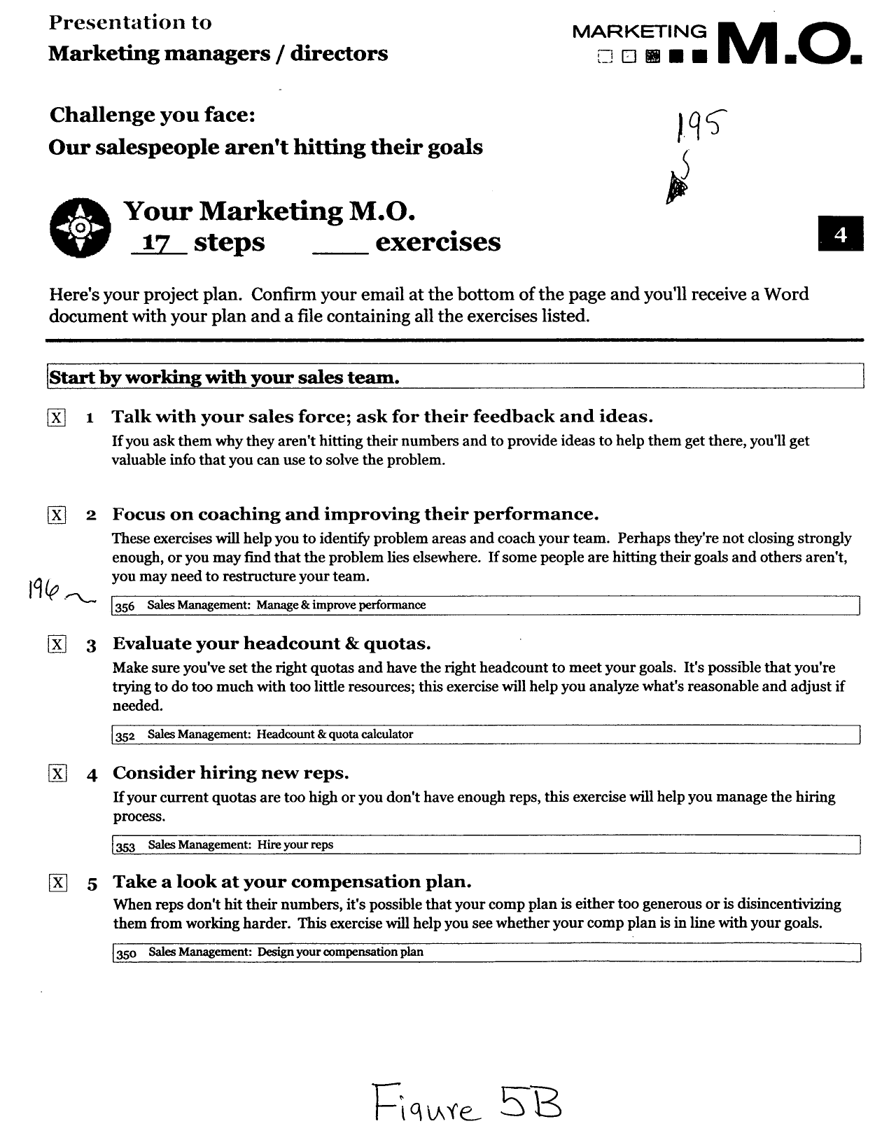

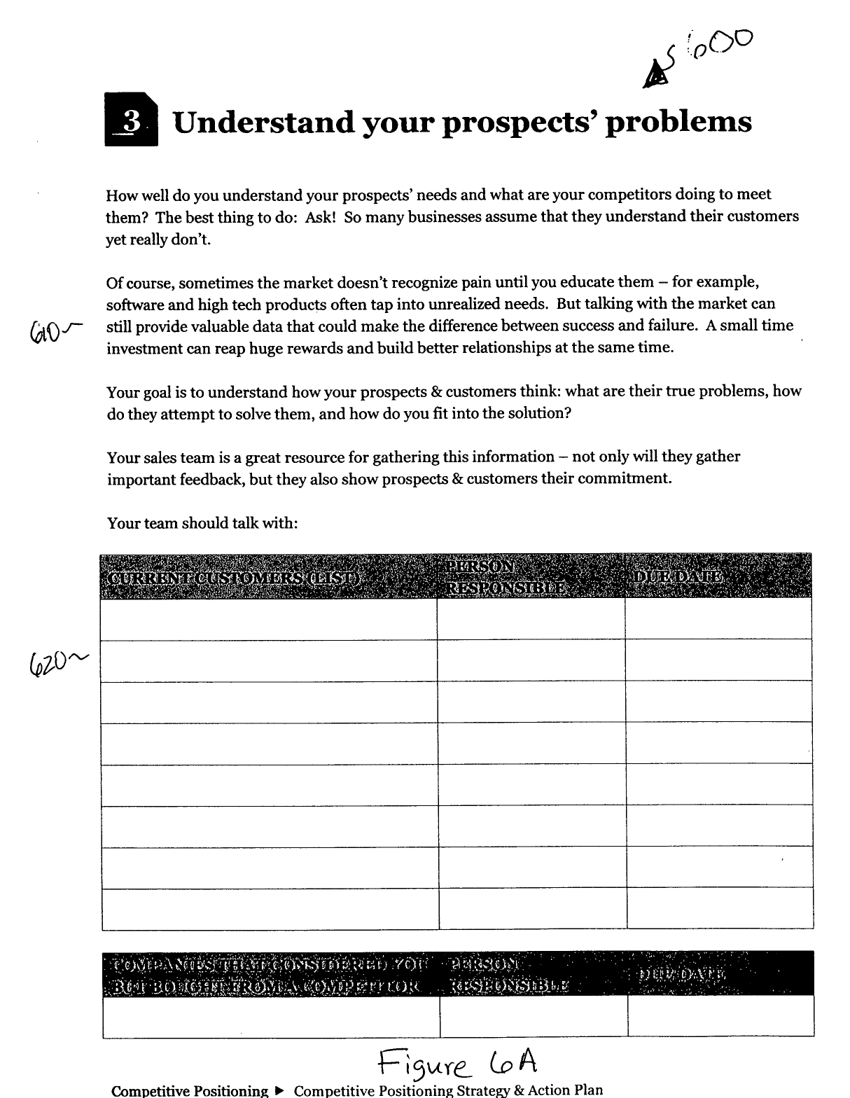

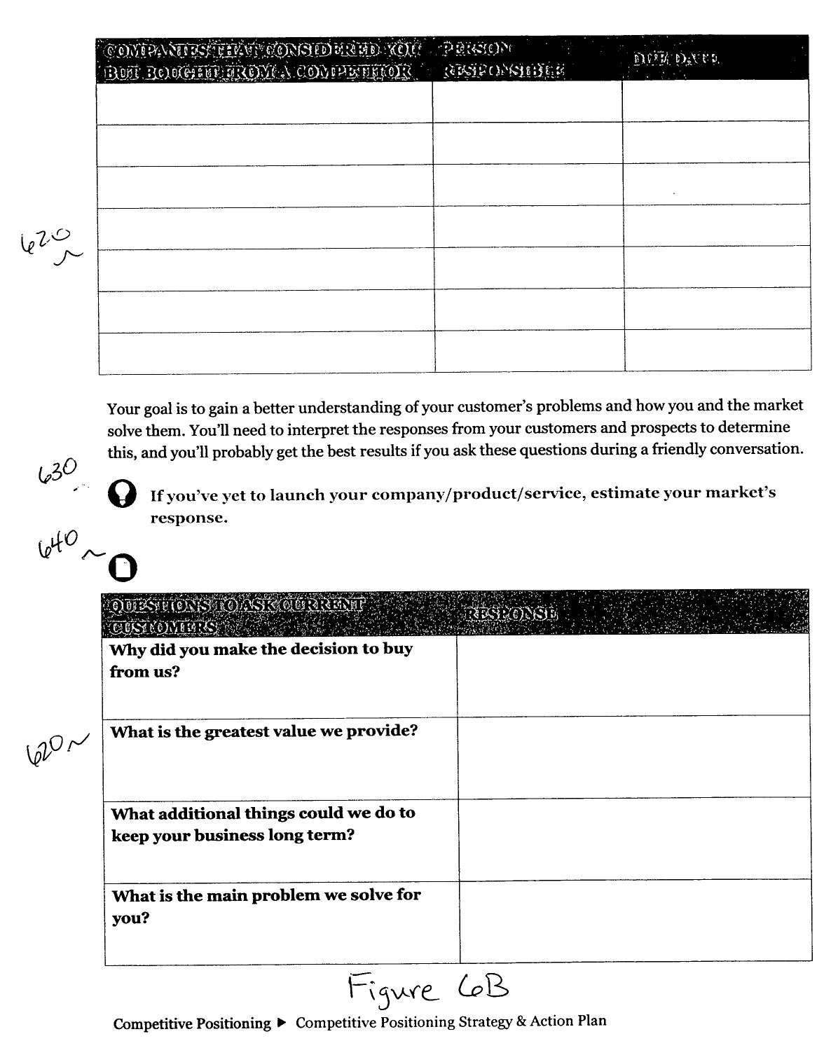

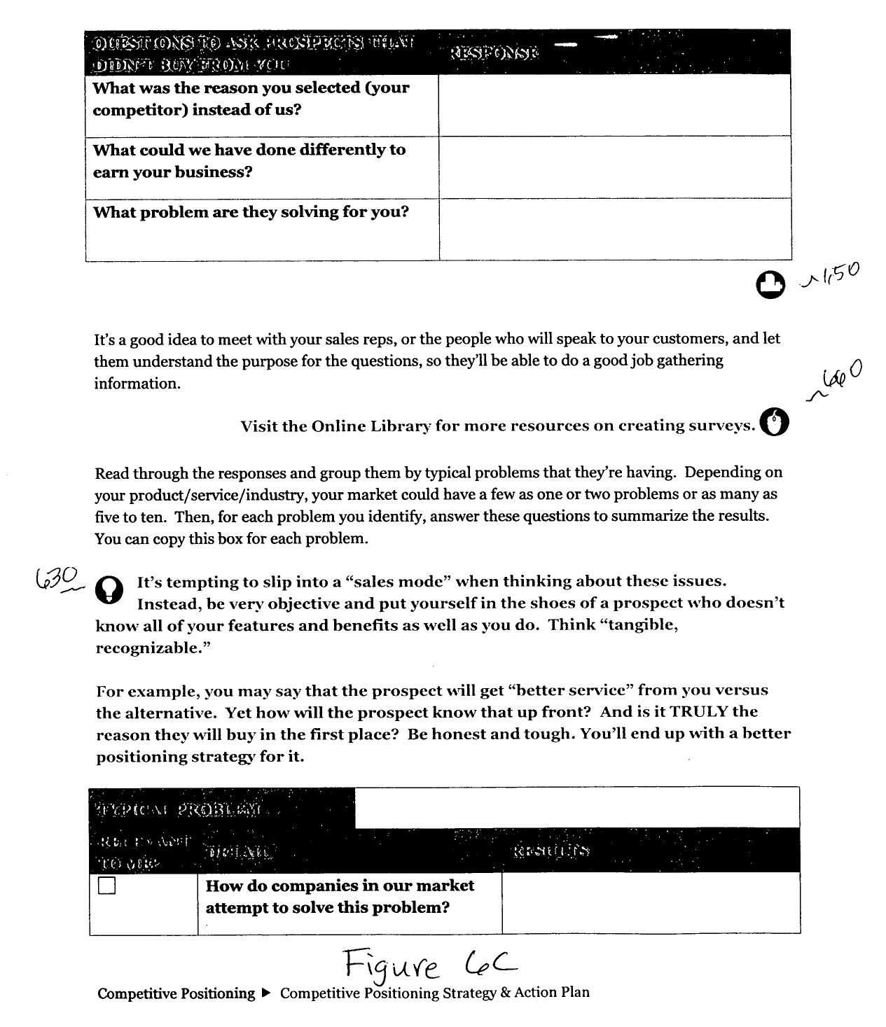

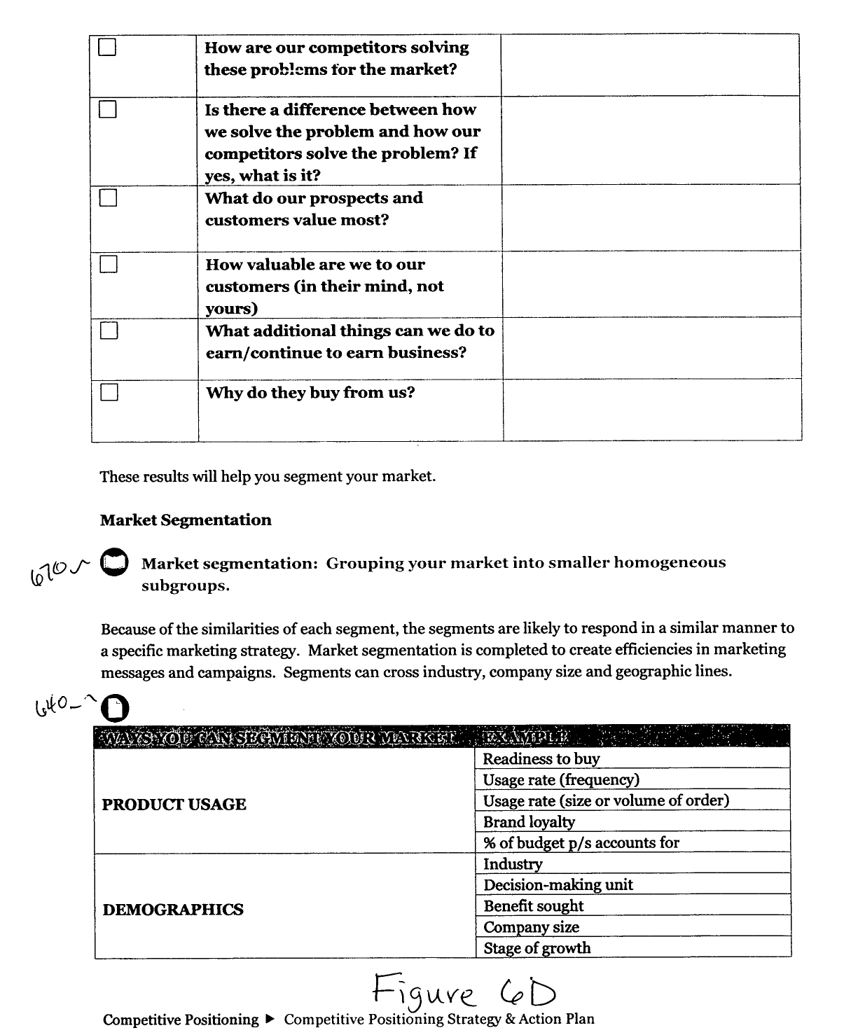

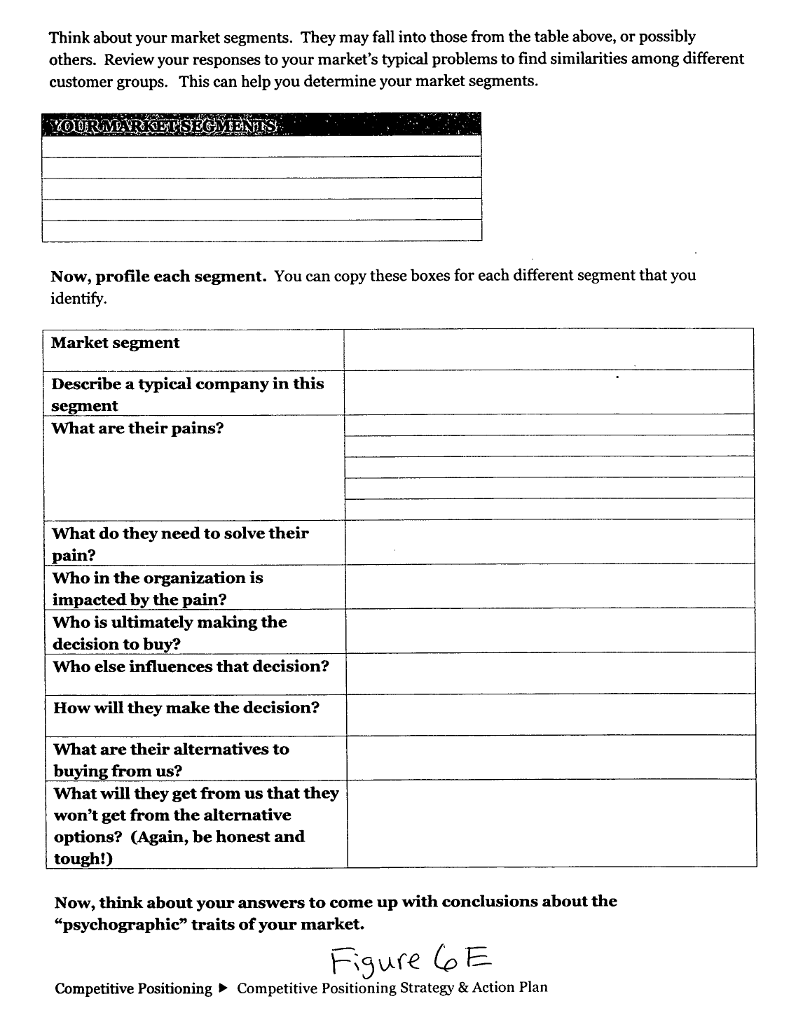

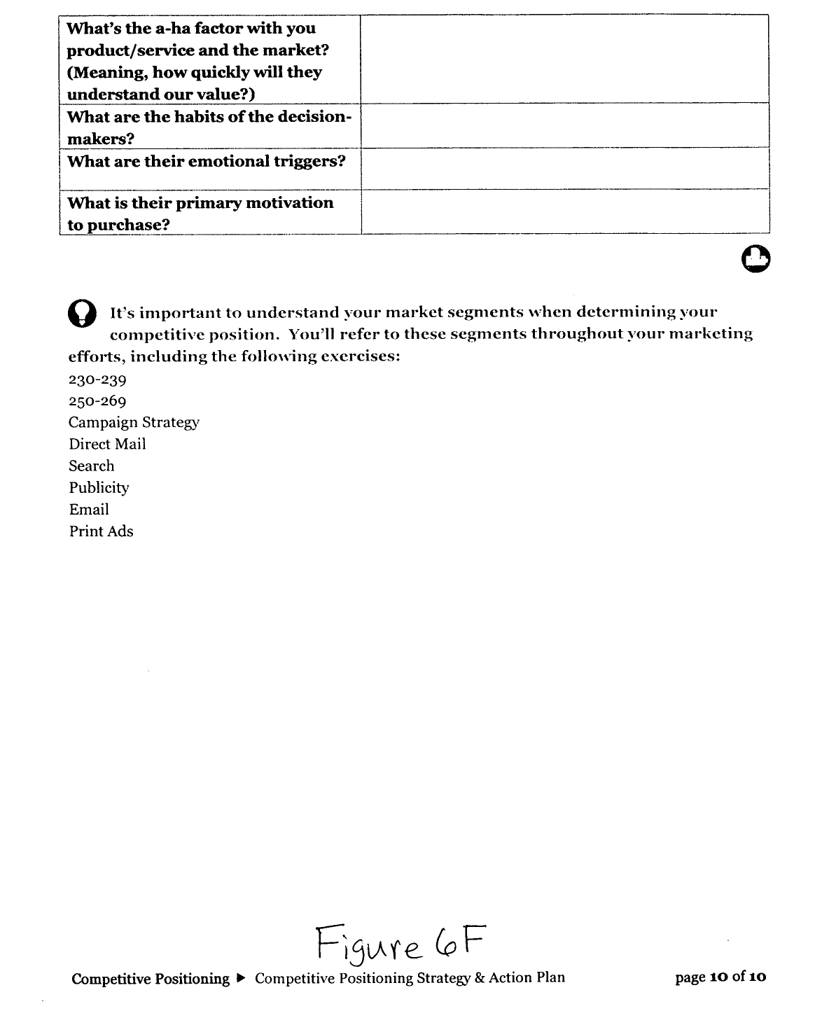

In step 180, an exercise for accomplishing the goal is delivered to the user. The exercise that is delivered is dependent on one or both of the received identification information and goal information. In this way, the exercise for accomplishing the goal may be customized both for the type of user (e.g., skill level) and/or the goal the user wishes to accomplish. In one embodiment, the exercise includes both a reading portion and an action portion. The reading portion may provide the user with relevant information regarding the subject and the specific goal to be accomplished as well as cites to other sources of information. The action portion allows the user to interact with the exercise and may allow the user to input information. Completion of the action portion produces a “deliverable” document. The deliverable itself may be the accomplishment of the goal or may be a tool used to accomplish the goal. The process for generating and interacting with the exercise and examples of types of exercises will be discussed in more detail below with reference to FIGS. 5A, 5B, and 6A to 6F below.

As such, the present invention provides a method for delivering a customized exercise for accomplishing a goal that includes an identification receiving step of receiving identification information regarding a user, a goal receiving step of receiving goal information, and a delivering step of delivering an exercise based on the identification information and the goal information.

Preferably, the method of the present invention is performed in a computing environment utilizing either a dedicated hardware system, software, or a combination of both. The method steps described above and below may be implemented in separate hardware units (e.g., ASIC chips), in one or more microprocessors, in computer program code, or in any combination of separate hardware units, microprocessors, and code.

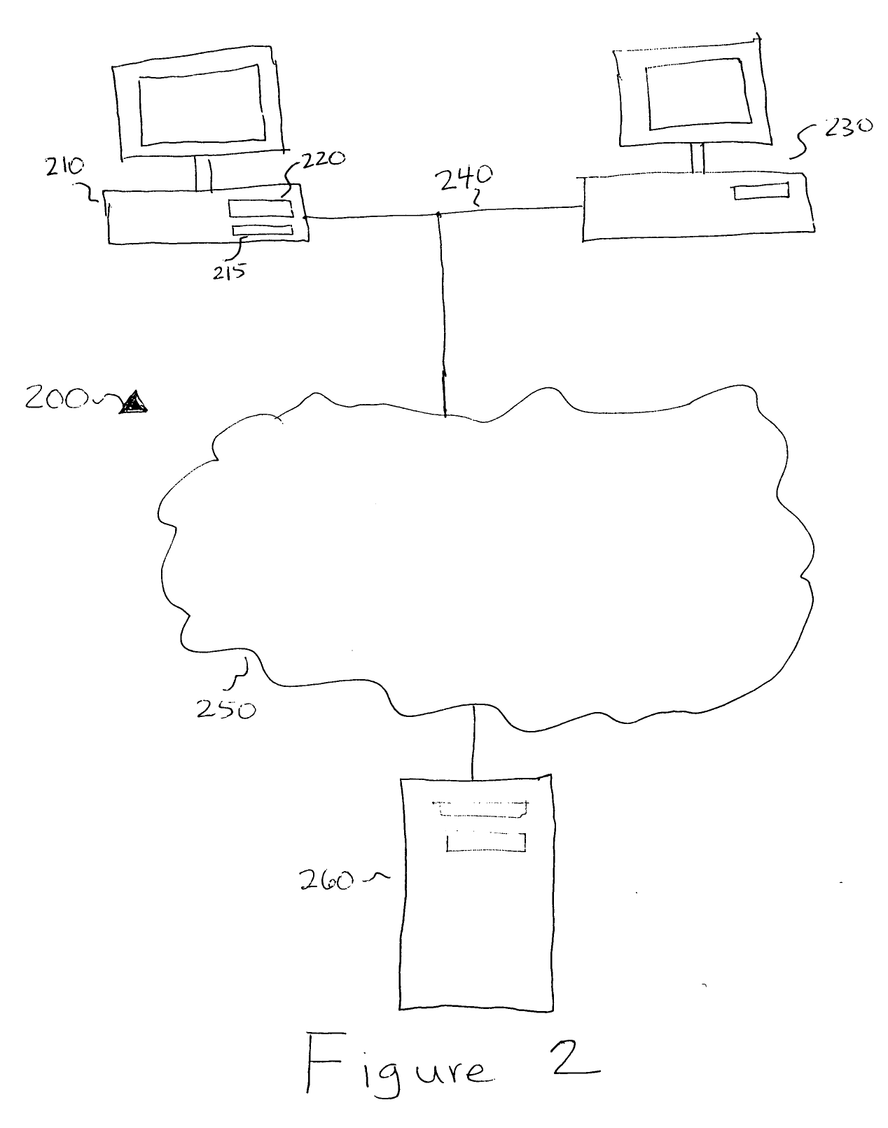

FIG. 2 depicts an example of a typical operating environment of the invention. System 200 may include a user computer 210, a local server 230, and an internet server 260. User computer 210 may be connected to local server 230 through local network 240. Local network 240 may be any type of network including LAN/WAN, Ethernet, or wireless. User computer 210 may also be connected to Internet server 260 through network 250 (e.g., the Internet). Each of the method steps may be carried out by local server 230 or Internet 260 through hardware and/or software, the relevant results of the steps then being displayed on user computer 210. Alternatively, some or all of the method steps may be carried out utilizing hardware and/or software on user computer 210.

Program code that performs the method of the invention may be stored on computer-readable media contained in user computer 210, local server 230 or Internet server 260. For example, program code may be stored on removable media (e.g., a CD) readable by removable media 215. In addition, program code may be stored on a hard drive 220. As such, program code may be resident on the user computer 210 or may be accessible via a network. According to one embodiment, the method is web-based whereby a user utilizing user computer 210 accesses a web page stored on an Internet server 260. The webpage includes program code and/or a link to program code that performs the method of the invention.

FIG. 3A depicts one embodiment of receive identification step 120 in more detail. Step 120 may include a display step 125 and a receive step 140. In step 125, a list of identification information is displayed to the user. Preferably, each piece of identification information in the list is selectable by the user. Selection of the information may be made using any technique, for example, a mouse or a touch screen.

The identification information displayed may differ depending on what subject matter or field of educational content is to be delivered. The identification information that is displayed allows the user to indicate what “type” of user they are so that exercises and content in the subject matter may be tailored to their user type. Preferably, the identification information displayed is different skill levels of the user. For example, the skill levels displayed may be based on job/position, intelligence level, years of experience, age, budget, role or relationship. All that is required in step 125 is a display of one or more pieces of selectable identification information that allows the user to identify themselves in a way that allows for delivery of a more customized exercise in a given subject area. When the user selects a piece of identification information that identification information is received in step 140.

FIG. 3B shows one example of the display of identification information in step 125. Two or more selectable skill levels 121-123 (skill level 1, skill level 2, skill level N) may be displayed to the user (e.g., on a computer screen). Skill levels 121-123 may be selected using any technique.

FIG. 3C shows a more specific example of the display of selectable identification information for use generating an exercise in the field of marketing. For the marketing field, the list of identification information displayed may include such selections as entrepreneur 121, executive 122, marketing director & manager, consultant, and aspiring marketer or current marketer 123. As shown in FIG. 3C, each skill level shown may also include additional text 126 to aid the user in making a selection. By allowing the user to identify himself in some way, the invention can tailor the exercise to his needs. For example, a marketing director may need more specific detail and less background information in an exercise geared for him, while an executive, who may have little marketing experience, may need considerably more background information. On the other hand, selection of entrepreneur may gear the delivered exercises to content applicable for early stage companies.

As another example, in the field of wedding planning it may be useful to identify the user by role or relationship. Exercises for planning the wedding may then be tailored to, for example, the father of the bride, mother of the groom, bride, maid of honor, or best man. Years of experience may be helpful for tailoring exercises for users in some fields, such as photography. Users with fewer years of experience may receive exercises with more definitions of technical jargon than a more seasoned photographer with greater years of experience. Exercises concerning advertising may be more accurately tailored to a specific user if the user identifies themselves by budget. For example, users with large budgets may be given exercises on creating television commercial scripts, while users with smaller budgets may be given exercises on drafting newspaper ad copy.

As showed in FIGS. 3A to 3C the identification process may only include one round of selection. However, two or more rounds of selection of identification information may be employed. For example, for certain subject matters the user may be first asked to identify himself by job position, then by years of experience, and then by budget. The selection and reception of identification information is not limited to one step, but may be any number of steps desired to tailor an exercise to a specific user.

FIG. 4A shows one embodiment of the receive goal information step 150. Step 150 may include a display step 155 and receive step 170. In step 155, a list of goals is displayed to the user for selection. A goal may be any challenge, process, need, desire or task that the user wishes to accomplish and/or solve. The goal information may be any information that allows the method to create an exercise that targets a specific problem, need or desire the user has for learning material in a certain subject area and/or accomplishing tasks within a certain subject area. In one embodiment of the invention, the lists of goals presented to the user are based on the identification information received in step 120. However, the list of goals displayed may be independent of the identification information for a particular subject.

As with the selection of identification information, the selection of goal information is not limited to one step, but may involve two or more steps. FIG. 4B shows one embodiment of display step 155 where goals are displayed and selected in two steps. In step 160, a list of broad goals is displayed. The list of broad goals defines broad areas that may be of concern to a user within a certain subject area. As with the identification information, each goal in the list of goals is selectable by the user using any technique. Based on the selection of a broad goal in step 160, a list of narrow goals is displayed in step 165. The narrow goals further define a goal or need within the subject area of the broad goal selected in step 160. Further specificity of the user's goal may be accomplished by adding additional goal displaying and selecting steps that further define the narrow goals.

FIG. 4C shows one example of the display of broad goal information in step 160. Two or more selectable goals 161-163 (broad goal 1, broad goal 2, broad goal N) may be displayed to the user (e.g., on a computer screen). Broad goals 161-163 may be selected using any technique.

FIG. 4D shows one example of a display of narrow goal information of step 165. Two or more selectable goals 166-168 (narrow goal 1, narrow goal 2, narrow goal N) may be displayed to the user (e.g., on a computer screen). Narrow goals 166-168 may be selected using any technique. As indicated above, the list of narrow goals displayed is based on the broad goal selected from the display in step 160. To reinforce this feature with the user, the selected broad goal 164 may be shown on the same page as the list of narrow goals.

To improve interaction with user, the list of goals is preferably presented as direct dialogue. FIG. 4E is an example of broad goals that may be displayed to a user in the marketing subject area. For example, a user may be presented with statements or questions concerning problems he may be facing such as: “I need to improve the way I market my services”, “My client isn't hitting goals”, “We're not hitting our revenue goals”, “Do you need to generate revenue quickly?”, “Nobody has heard of our company, so we need to get our name heard in the market”, and “We need effective ad copy.” FIG. 4F shows one example of a list of narrow goals based on the selection of broad goal 164 from FIG. 4E.

Once the identification information and the goal information are received, an exercise is created based on one or both of the identification and goal information. The exercises that are created are ones that are linked or associated with the identification and/or goal information. The exercises may be linked to the identification and goal information in any manner. For instance, a database of exercises may contain fields that list what goals and identification information match that exercise. In addition, exercise may be combined together to form a larger exercise based on the identification and/or goal information that is received.

In one embodiment of the invention a project plan 185 is created before delivering the actual exercise(s). FIG. 5A shows a sample project plan for recommended marketing exercises based on receipt of identification and goal information. In this case, the selected identification information (skill level) 124 is marketing manager/director and the selected narrow goal 169 is “Our salespeople aren't hitting their goals.” The sample project plan may show the number of recommended steps (exercises) 186 to solve the goal and/or a timetable to complete each exercise. In this way, the user is formed of the level commitment on his part needed to complete each exercise.

The steps or exercises may be separated by general sections 187 that guide the user to general areas of content. Typically, the general sections 187 include an outline of specific exercises 188 that are recommended for completion. Next to each specific exercise 188 there may be a checkbox 189. The checkbox 189 allows the user to unselect a specific exercise before delivery if that exercise is unwanted or has already been completed. Project plan 185 also includes a generate plan button 197 which delivers the selected (i.e., checked) exercises from the recommended plan to the user.

FIG. 5B, shows another embodiment of a project plan according to the invention. Detailed project plan 195 is similar to project plan 185, but also includes chapters 196 that point the user to the specific chapters of a larger group of materials on a subject from which the exercises will be generated. In this way, a user may consult a larger body of materials he may already own (e.g., a book or anthology) without having to have an individual exercise delivered to him. However, recommended and selected exercises are preferably delivered to the user on selection of generate plan button 197.

As discussed above, the invention may be implemented as a Web-based service. In such a case, delivery of the exercises may be made by e-mail or by download from a webpage. The exercises may be in any format including a text document format such as Microsoft Word®, a fillable postscript format, an .html webpage with fillable forms, spreadsheets such as Microsoft Excel®, a web-based java program, or other proprietary software applications that allow for user interaction with the exercise.

In addition to the exercises themselves, a user of the invention will also preferably receive a map showing the sub-sections of the selected subject, instructions on how to use the system, definitions of system terms, and a binder to hold exercises and plans. The map will function to show how all of the subjects of the material interact with each other. The invention will include an electronic version of the map that will allow users to view the typical subjects to complete prior to and after completing their subject of choice (e.g., through Flash or other graphical programming). The map will preferably delivered in the binder and electronically (e.g., on a website). Clicking on a subject graphic contained in the map will allow users to download all of the exercises within a subject—which is another way to navigate the material.

The exercise delivered to the user provides a tool for accomplishing a goal or solving a problem. The exercise will typically include two portions, a reading portion and an action portion. The reading portion provides the user with background information and relevant educational content useful in solving/accomplishing the user's goal. In addition, the reading portion may also include citations to sources of other information. These citations may direct the user to books, websites, articles or other sources of information. The citations may be text cites or may be direct links to electronic sources of information.

The exercise will also include an action portion. The action portion allows the user to interact with the exercise. The exercise may prompt the user to fill in lists, rank areas of expertise, input figures, conduct brainstorming sessions, narrow and define a problem, answer questions based on personal knowledge, conduct research, or direct user how to obtain unknown information. By interacting with the exercise and inputting information into the action portions of the exercise the user creates a “deliverable” document that may be a tool for accomplishing the user's goal or may be the accomplished goal in and of itself.

For example, an exercise in the marketing subject area may allow input of figures to create an advertising budget. Completion of the action portion may produce a completed budget that may be the user's goal. On other hand, completion of the action portion of a marketing exercise designed to help you “Understand your prospect's problems” may create a deliverable document that becomes a plan of action for dealing with prospects. Examples of possible deliverables include strategies, plans for action, figures, spreadsheets, calculators, evaluations for hiring, evaluations for employees, requests for proposal, timetables, budgets, telemarketing scripts etc. The exercise and associated deliverable created by completing the exercise may be any exercise or document that is applicable to solving a user's problem or accomplishing his goal with a hands-on, learning-by-doing approach.

FIGS. 6A to 6F show one example of an exercise 600. In particular, exercise 600 is in the marketing subject area and is geared toward helping a user understand his prospect's problems. As shown in FIG. 6A, the first page of exercise 600 includes a reading portion 610 and an action portion 620. The reading and action portion may be interspersed throughout an exercise in any order. The particular action portion in FIG. 6A allows the user to create a list of customers, assign persons responsible for contact, and set a due date for contact.

Turning to FIG. 6B, exercise 600 may also include various icons that help the user navigate the exercise. FIG. 6B shows tip icon 630 and deliverable icons 640. Tip icon 630 gives the user a visual cue for sources of help in completing an action section. In FIG. 6B, the tip suggests that for businesses that have yet to launch you should estimate customer's response to questions in the action portion at the bottom of the page. Deliverable icon 640 indicates the start of portion of the action that may be printed as a sub-deliverable

FIG. 6C shows two additional icons that may be present in an exercise. Print icon 650 allows the user to print a specific section of the exercise. Print icon 650 marks the end of the section that is printable as a sub-deliverable (deliverable icon 640 marks the start of the section). Effectively, this allows the user to create a “sub-deliverable.” As shown in FIG. 6C, print icon 650 allows the user to print out the action section where the user entered customer responses to questions concerning the user's company's marketing. FIG. 6C also includes a research icon 660. Selection of research icons presents the user with citations to additional sources of information concerning a subject. As shown in the example in FIG. 6C, research icon 660 is a link to Online Library that contains additional resources on how to create surveys. As shown in the FIG. 6F, suggestions for additional exercises may be included at the end of the exercise. FIG. 6D shows research icon 670 which present the user with definitions of terms used in the exercise.

One embodiment of the invention may include a knowledgebase database that may be utilized to analyze a user's completed action portion of the exercise and offer suggestions. Referring back to FIG. 2, such a database is preferably resident on Internet server 260, but may also be resident in user computer 210 or local server 230. The knowledgebase database would contain common answers or responses to action portions of the exercises. Information input by the user into the action portions may be compared to the common answers contained in the knowledgebase database. A user's answers, based on his user profile (experience level, or defined much further), can be matched to other answers for the same profile, or “common” or “typical” responses. In this way, the learning progress of the user can be measured by comparing the user's input to common answers for his skill level.

In addition, suggestions on how to use the exercise or what information to input into the exercise can be given to the user if the information the user input in the action portion does not match the common answers in the knowledgebase. In this way, the combination of an interactive exercise with a knowledgebase database creates for a virtual tutor to guide the user in accomplishing his goal and/or solving his problem.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A method for delivering a customized exercise for accomplishing a goal comprising:
an identification receiving step of receiving identification information regarding a user;
a goal receiving step of receiving goal information; and
a delivering step of delivering an exercise based on the identification information and/or the goal information.

2. The method of claim 1 further including:
an identification displaying step of displaying a list of identification information, the identification information being selectable,
wherein the identification receiving step receives identification information in response to a selection of identification information from the list.

3. The method of claim 1 further including:
a goal displaying step of displaying a list of goals, the goals being selectable,
wherein the goal receiving step receives goal information in response to a selection of a goal from the list.

4. The method of claim 3 wherein the goals include broad goals and narrow goals and wherein the goal displaying step comprises:
a first goal displaying step of displaying a list of broad goals, the broad goals being selectable; and
a second goal displaying step of displaying a list of narrow goals in response to a selection of a broad goal, the narrow goals being selectable,
wherein the goal receiving step receives goal information in response to a selection of a narrow goal from the list.

5. The method of claim 3 wherein the list of goals displayed in the goal displaying step is based on the identification information received in the identification information receiving step.

6. The method of claim 1 wherein the identification information includes information relating to a skill level of the user.

7. The method of claim 1 wherein the exercise includes a reading portion and an action portion, the action portion allowing for input of information by the user.

8. A computer-readable medium storing a computer program for delivering a customized exercise for accomplishing a goal, the computer program comprising:
an identification receiving code for receiving identification information regarding a user;
a goal receiving code for receiving goal information, the goal information including at least information relating to a problem the user desires to solve; and
a delivering code for delivering an exercise based on the identification information and/or the goal information.

9. The computer-readable medium of claim 8 further including:
an identification displaying code for displaying a list of identification information, the identification information being selectable,
wherein the identification receiving code receives identification information in response to a selection of identification information from the list.

10. The computer-readable medium of claim 8 further including:
a goal displaying code for displaying a list of goals, the goals being selectable,
wherein the goal receiving code receives goal information in response to a selection of a goal from the list.

11. The computer-readable medium of claim 10 wherein the goals include broad goals and narrow goals and wherein the goal displaying code comprises:
a first goal displaying code for displaying a list of broad goals, the broad goals being selectable; and
a second goal displaying code for displaying a list of narrow goals in response to a selection of a broad goal, the narrow goals being selectable,
wherein the goal receiving code receives goal information in response to a selection of a narrow goal from the list.

12. The computer-readable medium of claim 10 wherein the list of goals displayed by the goal displaying code is based on the identification information received by the identification information receiving code.

13. The computer-readable medium of claim 8 wherein the identification information includes information relating to a skill level of the user.

14. The computer-readable medium of claim 8 wherein the exercise includes a reading portion and an action portion, the action portion allowing for input of information by the user.

15. A system for delivering a customized exercise for accomplishing a goal comprising:
an identification receiving unit for receiving identification information regarding a user;
a goal receiving unit for receiving goal information, the goal information including at least information relating to a problem the user desires to solve; and
a delivering unit for delivering an exercise based on the identification information and/or the goal information.

16. The system of claim 15 further including:
an identification displaying unit for displaying a list of identification information, the identification information being selectable,
wherein the identification receiving unit receives identification information in response to a selection of identification information from the list.

17. The system of claim 15 further including:
a goal displaying unit for displaying a list of goals, the goals being selectable,
wherein the goal receiving unit receives goal information in response to a selection of a goal from the list.

18. The system of claim 17 wherein the goals include broad goals and narrow goals and wherein the goal displaying unit comprises:
a first goal displaying unit for displaying a list of broad goals, the broad goals being selectable; and
a second goal displaying unit for displaying a list of narrow goals in response to a selection of a broad goal, the narrow goals being selectable,
wherein the goal receiving unit receives goal information in response to a selection of a narrow goal from the list.

19. The system claim 17 wherein the list of goals displayed by the goal displaying unit is based on the identification information received by the identification information receiving unit.

20. The system of claim 15 wherein the identification information includes information relating to a skill level of the user.

21. The system of claim 26 wherein the exercise includes a reading portion and an action portion, the action portion allowing for input of information by the user.
